(19) United States
(12) Patent Application Publication
(10) Pub. No.: US 2014/0111429 A1
(43) Pub. Date: Apr. 24, 2014

(54) MULTIPLE FINGERS, MULTIPLE STEP GESTURE

(71) Applicant: CIRQUE CORPORATION, Salt Lake City, UT (US)

(72) Inventor: Michael D. Layton, Salt Lake City, UT (US)

(73) Assignee: CIRQUE CORPORATION, Salt Lake City, UT (US)

(21) Appl. No.: 14/060,897

(22) Filed: Oct. 23, 2013

Related U.S. Application Data
(60) Provisional application No. 61/717,342, filed on Oct. 23, 2012.

(51) Int. Cl. G06F 3/041

(52) U.S. Cl. CPC G06F 3/0416
USPC 345/157; 345/173

(57) ABSTRACT

A system and method for performing a multi-finger and multi-step or action gesture on a touch sensor, the gesture including at least one step, action or phase of the gesture is characterized by only a single finger being present on the touch sensor, but always incorporating another step, action or phase having at least two fingers present.

### BACKGROUND OF THE INVENTION

1. Field of the Invention

This invention relates generally to touch sensors. More specifically, the present invention is a system and method for entering multi-finger gestures that have multiple steps or actions that always include having one step wherein only a single finger is present on the touch sensor during the gesture.

2. Description of Related Art

There are several designs for capacitance sensitive touch sensors. It is useful to examine the underlying technology to better understand how any capacitance sensitive touch sensor can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24. Although the CIRQUE® touchpad described above uses a grid of X and Y electrodes 12, 14 and a separate and single sense electrode 16, the sense electrode can actually be the X or Y electrodes 12, 14 by using multiplexing. It should also be understood that the CIRQUE® touchpad technology described above can be modified in order to function as touch screen technology.

### BRIEF SUMMARY OF THE INVENTION

In a first embodiment, the present invention is a system and method for performing a multi-finger and multi-step or action gesture on a touch sensor, the gesture including at least one step, action or phase of the gesture is characterized by only a single finger being present on the touch sensor, but always incorporating another step, action or phase having at least two fingers present.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be modified to operate in accordance with the principles of the present invention.

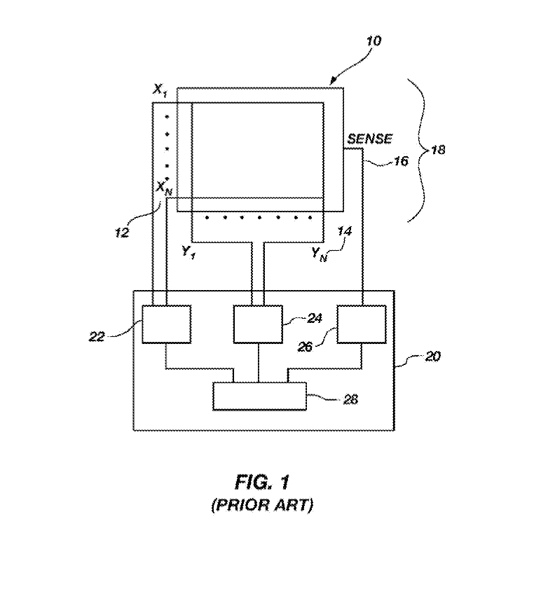

FIG. 2 is a block diagram showing components of a system that may be used to perform the gestures described herein.

FIG. 3 is a flowchart showing an embodiment of the present invention.

FIG. 4 is a flowchart showing an embodiment of the present invention.

FIG. 5 is a flowchart showing an embodiment of the present invention.

FIG. 6 is a flowchart showing an embodiment of the present invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document may be used interchangeably with “proximity sensor”, “touch and proximity sensor”, “capacitive touch sensor”, “touch panel”, “touchpad” and “touch screen”, except when explicitly distinguished from the other terms.

It should also be understood that the use of the term “gesture” throughout this document may be used interchangeably with the “gesture function” and “function”.

Multi-finger gestures are used in many multi-touch sensing devices. The use of multi-finger gestures may enable improved control of touch sensors, an increase in the total number of gestures that can be performed, an improvement in the intuitive nature of the gesture, or increased differentiation between the gestures that can be performed.

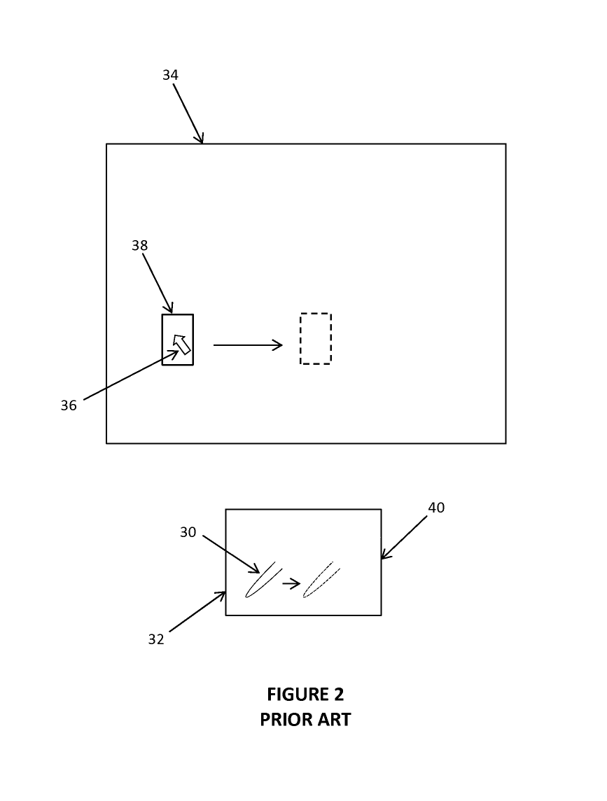

FIG. 2 is an illustration of one example of a problem that may be solved by a first embodiment of the invention. It is often desirable to drag an object from one location to another on a display screen or a touch screen. It is desirable to use a function known as a drag lock. This embodiment is most applicable to a touchpad, but may be adapted to any type of touch sensor.

As shown in FIG. 2, a finger 30 is performing the drag lock function using a touch sensor 32 and an associated display 34 having a cursor 36 that is controlled by the touch sensor. It should be understood that the objects shown are not to scale, and are only being used to illustrate aspects of the present invention.

The drag lock function must be initiated and terminated in a manner that is recognizable to the touch sensor 32. In this embodiment, the drag lock function may be initiated by performing a gesture that may be characterized by a “tap and a half” on the touch sensor 32. In other words, the finger 30 taps the touch sensor 32 once and then touches and remains on the touch sensor. Other gestures may be used to initiate a function and the tap and a half gesture should not be considered as limiting.

On the display 34, the cursor 36 has been positioned over the object 38 or icon to be dragged before the drag lock function is initiated. Once the cursor 36 has been “locked” to the object 38 by performing the tap and a half gesture, the finger 30 may move across the surface of the touch sensor 32, causing a corresponding movement of the object 38 on the display 34. Movement of the object 38 across the display 34 may continue until one of several events takes place.

The events include 1) moving the object 38 until the object reaches an edge of the display 34 and then does not move off the display, 2) the object reaches the edge of the display and disappears off the display, or 3) the object does not reach an edge of the display, but the finger 30 reaches a perimeter 40 of the touch sensor 32. The perimeter 40 may be any edge of the touch sensor 32.

If this third event occurs, the user may desire to continue to drag the object 38 across the display 34 in any direction, including the direction it was moving before the perimeter 40 of the touch sensor 32 was reached. The drag lock function enables a user to continue to drag the object 38 after reaching the perimeter 40 of the touch sensor 32 without having to re-initiate the drag lock function.

Some drag lock functions used in the industry rely on the touch sensor 32 being able to determine whether or not the user intends to continue dragging. For example, in one system using the drag lock feature, the user may lift the finger 30 at any time and then place it anywhere on the touch sensor 32 and may continue dragging the object 38 as though the finger was never off the surface of the touch sensor. Thus, reaching the perimeter 40 is not required to perform the drag lock function. The drag lock feature may continue until the finger 30 performs some action to disengage the drag lock function, such as tapping on the touch sensor 32.

In another drag lock function, the finger 30 may continue to drag the object 38 only if the finger was lifted after reaching the perimeter 40 of the touch sensor 32. Lifting the finger off the touch sensor 32 in any location other than the perimeter 40 will automatically terminate the drag lock feature.

An aspect of both of these drag lock features described above is that they are gestures that only require a single finger. However, it may the case that multi-finger gestures may be more intuitive to a user of a touch sensor 32, or to a user of a touch sensor that has multi-touch capabilities.

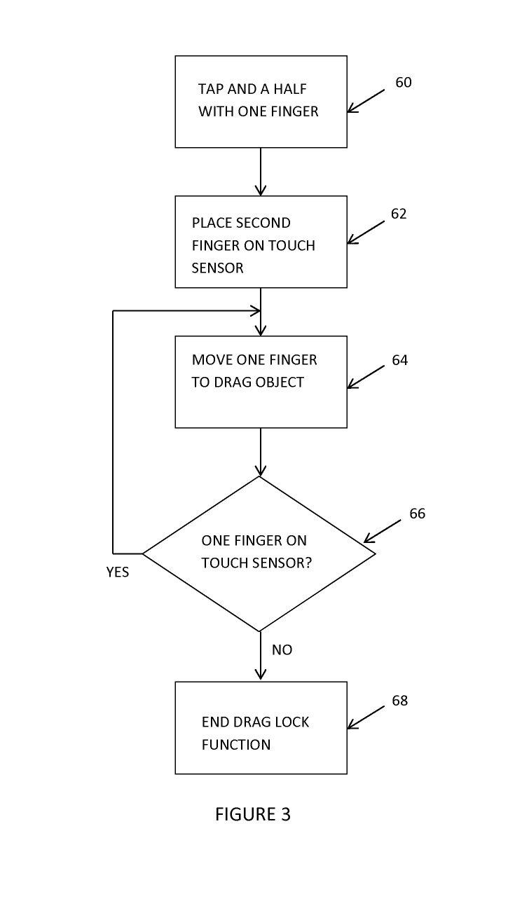

As shown in the flowchart of FIG. 3, in the first embodiment of the present invention, the drag lock feature may be initiated or engaged by performing the tap and a half gesture with a first finger on the touch sensor 32 in step 60. The next step 62 is that a second finger may now be placed on the touch sensor 32. Therefore, the drag lock feature was engaged by a first finger, and then a second finger is placed on the touch sensor 32. At this step 64, either the first finger or the second finger may be moved to drag the object 38 on the display 34 while the other finger remains planted where it is on the touch sensor 32.

The touch sensor 32 determines if there is at least one finger on the touch sensor in step 66. If at least one finger is on the touch sensor 32, then the drag lock function has not been terminated, and the drag lock function continues until both the first and the second fingers are removed from the touch sensor 32.

Thus the user may lift the first or the second finger off the surface of the touch sensor 32 (liftoff) and then place the finger back down on the touch sensor (touchdown) at any location and begin to move either finger, and the object 38 will continue to be dragged across the display. The drag lock function continues until both fingers are lifted from the touch sensor 32 and the drag lock function is terminated in step 68.

Any number of liftoff and touchdown events can occur with the first or the second finger while at least one finger remains on the touch sensor 32. During this embodiment, one finger always remains on the touch sensor 32 while the other finger is moved around the surface of the touch sensor, is lifted off or makes touchdown.

It should be apparent that the first and the second fingers do not have to be on the same hand. For example, the index finger of two hands may be used as the first and second fingers. Thus, the index finger of one hand may engage the drag lock function using a single finger gesture. Then the index finger of the other hand may be used to drag the object 38 across the display, repeatedly lifting off and making touchdown on the surface of the touch sensor 32

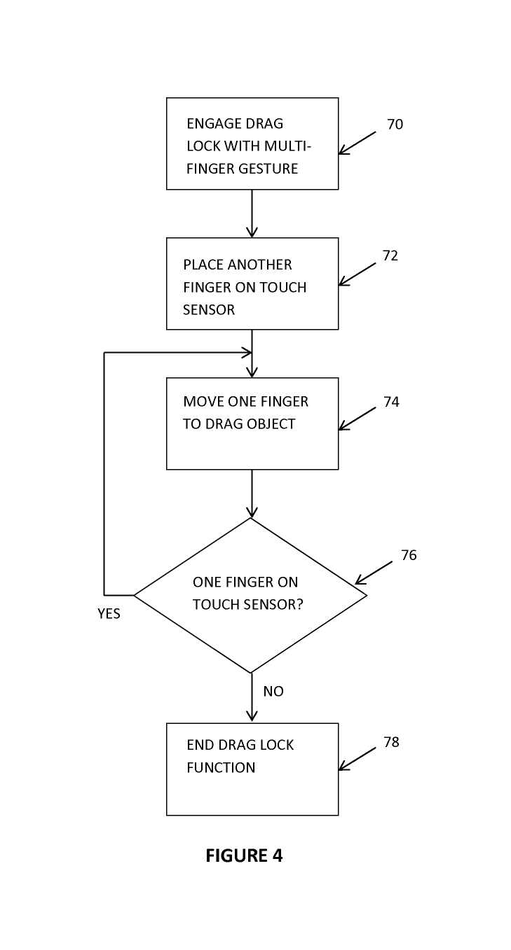

FIG. 4 is an illustration of a flowchart that describes a second embodiment of the present invention. In FIG. 4, engaging the drag lock function is not limited to a single finger gesture such as performing the tap and a half gesture. Engaging the drag lock function may also be a multi-finger gesture as in step 70. For example, a two finger tap and a half gesture may be used to initiate the drag lock function in step 70, and then another finger may perform touchdown on the touch sensor 32 in step 72. One finger may be moved in step 74 in order to perform dragging of the object 38. Again, the drag lock function may continue until all of the fingers are lifted off the surface of the touch sensor 32. It should be understood that step 72 may or may not be performed.

The method of this second embodiment determines if there is at least one finger on the touch sensor 32 in step 76. If at least one finger is on the touch sensor 32, then the drag lock function has not been terminated, and the drag lock function continues until all fingers are removed from the touch sensor 32. Thus, the drag lock function continues until all fingers are lifted from the touch sensor 32 and the drag lock function is terminated in step 78.

It should again be understood that the fingers being used may be from more than one hand. For example, the drag lock function may be engaged using two fingers from one hand, then a third finger on the other hand may be used to drag the object 38 across the display.

In an alternative embodiment, the drag lock function is engaged with a multi-finger gesture such as two fingers making contact with the touch sensor 32, and then one of the fingers being moved to drag the object 38.

In another alternative to the second embodiment above, a three finger activated drag lock function may be terminated by lifting off two fingers from the touch sensor 32, such as the first two fingers that initiated the drag lock function.

An aspect of the second embodiment is that multi-finger gestures may include multiple steps or phases. For example, the phases may include initiating or engaging the gesture, performance of the gesture, and termination of the gesture. In this second embodiment, initiation, performance and termination may include the use of one or more fingers in any phase, but may always include multiple fingers in at least one of the phases of the gesture. Use of fingers may also include the action of liftoff. By changing the number of fingers being used or which specific fingers are being used in a particular phase, the functionality of a gesture may be changed or augmented. However, it is preferred but not required that the gestures may terminate when all the fingers have been lifted off of the touch sensor 32.

For example, three fingers may be required to engage a function, one or two fingers may be used to perform the function, and then all fingers are removed to terminate the function. A completely different function may be performed by using two, four or five fingers to engage the function. Furthermore, one or multiple fingers may be used to perform the function.

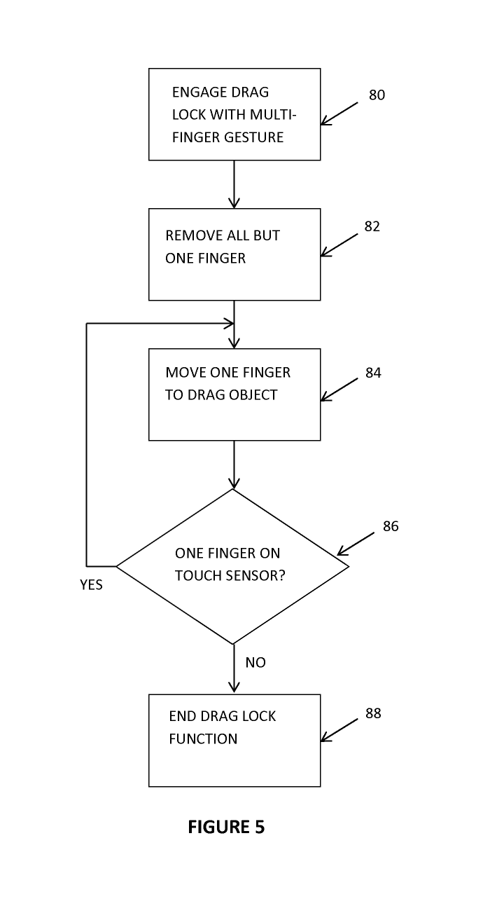

FIG. 5 shows that in a third embodiment of the invention, a gesture may be initiated using any desired multi-finger process in step 80. However, once the gesture is initiated, it is observed that it may be easier to perform a gesture using a single finger. Controlling a gesture may be easier with a single finger because no other fingers interfere with movement. Furthermore, it may be easier to control the gesture using a single index finger because this finger is often used for single finger tasks.

Accordingly, it may be preferred in this embodiment to initiate a gesture using two or more fingers, but then all fingers are lifted from the touch sensor except for the index finger in step 82 which is used to perform the gesture. The finger is then moved to perform the drag lock function in step 84. If the finger has not been removed from the touch sensor in step 86, then the drag lock function continues. However, if the finger is removed, the drag lock function is terminated in step 88.

In an alternative embodiment, more than one finger may be moved to drag the object in steps 64, 74 and 84.

Another aspect of the embodiments shown in FIGS. 3, 4 and 5 is that it may be possible to add or subtract a finger from the surface of the touch sensor 32 and cause no change in the function being performed. Thus, the number of fingers required to initiate the gesture function is still not changed, but while the gesture is being performed, adding or subtracting fingers may not modify the gesture function.

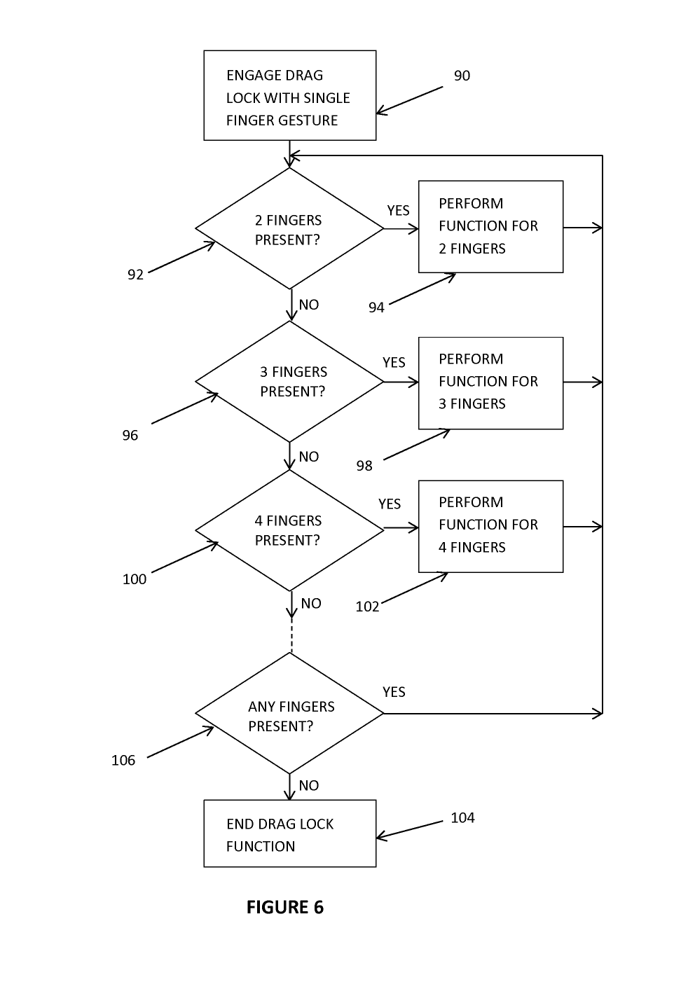

FIG. 6 shows in a flowchart that in a fourth embodiment, a function such as cursor control may be performed by a single finger and is typically initiated by a single finger in step 90. However, while the single finger is on the touch sensor 32, a second, third, fourth or fifth fingers may also make touchdown on the touch sensor 32 to modify the cursor function. Thus, additional fingers may activate a new function or modify a function already being performed, such as cursor control.

Therefore, if there are a total of two fingers present on the touch sensor 32 as determined in step 92, then a first modified cursor control function may be performed in step 94 and continues to be performed until the number of fingers on the touch sensor changes or all fingers are removed.

If there are not two fingers present, the algorithm then determines if three fingers are present in step 96. If three fingers are present, then the function may be modified in step 98. If not, then the algorithm determines if four fingers are present in step 100. If four fingers are present, then the function is modified in step 102. If not, the algorithm may continue to determine the exact number of fingers that are present and execute the associated modification of the function being performed. The algorithm then determines if no fingers are present in step 106. If fingers are present, then the algorithm continues to determine if two or more fingers are present and then executes the modified function, or executes the first function from step 90. When no fingers are present, the function is terminated in step 104.

The embodiment in FIG. 6 is not limited to four fingers. Any number of fingers may be present and have a unique function modification associated with the unique number of fingers.

The figures and examples given may refer to any function that can be performed and controlled using a touch sensor, and not just the examples given. For example, the cursor control function may be replaced by any other function in FIG. 6.

An example of a function that may be controlled as described in FIG. 6 is the speed of movement of a cursor. The speed at which a cursor moves across the display may be changed by the addition or subtraction of fingers. Thus, the first finger may be controlling movement of a cursor, then a second finger making touchdown increases the speed of the cursor to a second speed. The addition of a third finger may increase the speed of the cursor to a third speed. The removal of the third finger may reduce the speed of the cursor to the second speed, etc. This is an example of augmentation of a gesture that was being performed, but then changed with the addition or subtraction of other fingers.

In another embodiment, a panning gesture is being performed by two fingers. The speed of the panning gesture may be controlled by adding or subtracting additional fingers. Thus, while two fingers may always required for the pan gesture function, adding other fingers increases the speed and subtracting fingers decreases the speed, as long as two fingers are always present. Thus, the slowest speed for the pan gesture function may be with the first two fingers that are required for the panning function itself.

Another alternative drag function may be performed by a single finger until the finger reaches the edge of the touch sensor. When the perimeter 40 of the touch sensor 32 is reached and the first finger stops, a second finger making touchdown on the touch sensor may initiate an edge motion function. The edge motion function may be to continue movement of the object in the same direction as when the first finger reached the perimeter 40 of the touch sensor 32 and stopped. The edge motion function may be terminated by lifting the second finger.

In another alternative embodiment, the cursor or drag gesture may be performed by a single finger. However, the cursor or the cursor and an object being dragged by the cursor may jump in the direction being traveled by tapping on the touch sensor with a second finger. This jump gesture may occur when the first finger is anywhere on the touch sensor 32 or only at the edge of the touch sensor, or both. This jump gesture may be especially useful when a very small touch sensor is controlling movement of a relatively larger area of a display.

The present invention describes a number of unique gestures that may be initiated by making touchdown with a unique number of fingers. Then, the present invention is able to either modify the same gesture being performed by changing the number of fingers on the touch sensor, or changing the gesture itself.

In an alternative embodiment, the gestures are not limited to taps or making touchdown in order to initiate, perform, modify or change a gesture. For example, the present invention may also include the use of sweeping motions with one or more fingers. Thus, a tap followed by a sweep might initiate one gesture, but a tap and then a hold initiates a different gesture. Another example might be a sweep motion with two fingers followed by touchdown with one or more fingers. Thus, combinations of one or more fingers making contact with the touch sensor in combination with a sweeping motion by one or more fingers may also be characterized as unique gestures.

Another aspect of the invention is that removal of all fingers may not immediately terminate a gesture. Liftoff and then touchdown on the touch sensor 32 before a countdown timer has expired may enable the user to continue the function without having to reinitiate the function.

The gestures that may be performed by the present invention are any functions that may be input or controlled by a touch sensor. Such functions include but should not be considered as limited to cursor control, drag lock control, scrolling control, page control, panning control, zoom control, etc.

It is to be understood that the above-described arrangements are only illustrative of the application of the principles of the embodiments of the invention. Numerous modifications and alternative arrangements may be devised by those skilled in the art without departing from the spirit and scope of the present invention. The appended claims are intended to cover such modifications and arrangements.

What is claimed is:

1. A method for performing a function using a gesture having at least one phase using a single finger and at least one other phase using multiple fingers, said method comprising:
1) providing a touch sensor for detecting and tracking multiple fingers, the touch sensor being capable of recognizing a gesture having at least an initiating, a performing and a terminating phase;
2) using at least two fingers during the initiating phase to initiate a gesture;
3) performing the gesture using one finger during the performing phase; and
4) terminating the gesture by removing all of the fingers from the touch sensor during the terminating phase, wherein only one finger is present during at least one phase of the gesture and wherein multiple fingers are present during at least one different phase of the gesture.

2. The method as defined in claim 1 wherein the method further comprises placing another finger on the touch sensor between the initiating phase and the performing phase.

3. The method as defined in claim 1 wherein the method further comprises removing all but one finger before the performing phase, and performing the gesture using the one remaining finger.

4. The method as defined in claim 1 wherein the method is further comprised of selecting the function from the group of functions comprised of cursor control, drag lock control, scrolling control, page control, panning control and zoom control.

5. The method as defined in claim 1 wherein the method is further comprised of:
1) activating a countdown timer after all of the fingers are removed from the touch sensor; and
2) continuing the gesture if at least one finger makes touchdown on the touch sensor before the countdown timer expires.

6. A method for performing a function using a gesture having at least one phase using a single finger and at least one other phase using multiple fingers, said method comprising:
1) providing a touch sensor for detecting and tracking multiple fingers, the touch sensor being capable of recognizing a gesture having at least an initiating, a performing and a terminating phase;
2) using one finger during the initiating phase to initiate a gesture;
3) placing a second finger on the touch sensor;
4) performing the gesture using at least two fingers on the touch sensor during the performing phase, wherein one finger is moved to perform the gesture; and
5) terminating the gesture by removing all of the fingers from the touch sensor during the terminating phase, wherein only one finger is present during at least one phase of the gesture and wherein multiple fingers are present during at least one different phase of the gesture.

7. The method as defined in claim 6 wherein the method is further comprised of:
1) activating a countdown timer after all of the fingers are removed from the touch sensor; and
2) continuing the gesture if at least one finger makes touchdown on the touch sensor before the countdown timer expires.

8. A method for performing a function using a gesture having at least one phase using at least one finger and at least one other phase using a different number of fingers, said method comprising:
1) providing a touch sensor for detecting and tracking multiple fingers, the touch sensor being capable of recognizing a gesture having at least an initiating, a performing and a terminating phase;
2) initiating a gesture using at least one finger during the initiating phase;
3) performing the gesture using at least one finger during the performing phase, wherein a different number of fingers are used in the initiating phase and the performing phase; and
4) terminating the gesture by removing all of the fingers from the touch sensor.

9. The method as defined in claim 8 wherein the method is further comprised of:
1) activating a countdown timer after all of the fingers are removed from the touch sensor; and
2) continuing the gesture if at least one finger makes touchdown on the touch sensor before the countdown timer expires.

10. A method for performing a function using a gesture having at least one phase using at least one finger and at least one other phase using a different number of fingers, said method comprising:
1) providing a touch sensor for detecting and tracking multiple fingers, the touch sensor being capable of recognizing a gesture having at least an initiating, a performing and a terminating phase;
2) initiating a gesture using at least two fingers during the initiating phase;
3) removing all but one finger;
4) performing the gesture using one finger during the performing phase; and
5) terminating the gesture by removing all of the fingers from the touch sensor.

11. A method for performing a function using a gesture having at least one phase using at least one finger and at least one other phase using a different number of fingers, said method comprising:
1) providing a touch sensor for detecting and tracking multiple fingers, the touch sensor being capable of recognizing a gesture having at least an initiating, a performing and a terminating phase;
2) initiating a gesture using one finger during the initiating phase;
3) performing the gesture while determining if any other fingers are dynamically added or removed from the touch sensor during the performing phase, wherein additional fingers are used to modify the gesture being performed, and wherein the gesture being modified is the gesture initiated during the initiating phase; and
4) terminating the gesture by removing all of the fingers from the touch sensor.

12. The method as defined in claim 11 wherein the method is further comprised of:
1) activating a countdown timer after all of the fingers are removed from the touch sensor; and
2) continuing the gesture if at least one finger makes touchdown on the touch sensor before the countdown timer expires.

13. A method for performing a function using a gesture having at least one phase using at least one finger and at least one other phase using a different number of fingers, said method comprising:
1) providing a touch sensor for detecting and tracking multiple fingers, the touch sensor being capable of recognizing a gesture having at least an initiating, a performing and a terminating phase;
2) initiating a gesture using at least one finger during the initiating phase;
3) performing the gesture while determining if any other fingers are dynamically added or removed from the touch sensor during the performing phase, wherein additional fingers are used to modify the gesture being performed, and wherein the gesture being modified is the gesture initiated during the initiating phase; and
4) terminating the gesture by removing all of the fingers from the touch sensor.

14. The method as defined in claim 1 wherein the method is further comprised of:
1) activating a countdown timer after all of the fingers are removed from the touch sensor; and
2) continuing the gesture if at least one finger makes touchdown on the touch sensor before the countdown timer expires.
